(19) United States
(12) Patent Application Publication
(10) Pub. No.: US 2026/0367878 A1
(43) Pub. Date: Nov. 19, 2026

(54) SYSTEMS, APPARATUS, AND METHODS FOR MANAGING PROGRAMMABLE AGENTS

(71) Applicant: Fisher-Rosemount Systems, Inc., Round Rock, TX (US)

(72) Inventors: Cheyenne Villanueva Hernandez, Cedar Park, TX (US); Mark Nixon, Thorndale, TX (US)

(21) Appl. No.: 19/210,819

(22) Filed: May 16, 2025

(51) Int. Cl. G06F 8/30; G05B 19/042; G06F 21/64

(52) U.S. Cl. CPC G06F 8/311; G05B 19/0426; G06F 21/64

(57) ABSTRACT

are disclosed. An example process control system includes a programmable agent; at least one programmable circuit to store, at a function block, a modification to code associated with the programmable agent, the modification received via the function block; and interface circuitry to cause the code including the modification to be provided to the programmable agent, the programmable agent to execute the code including the modification to generate an output for the process control system.

### FIELD OF THE DISCLOSURE

This disclosure relates generally to process control systems and, more particularly, to systems, apparatus, and methods for managing programmable agents.

### BACKGROUND

In a process control system, a programmable agent can autonomously monitor and manage processes, perform tasks, or otherwise interact with the process control system.

### BRIEF DESCRIPTION OF THE DRAWINGS

FIG. 1 is a block diagram of an example process control system including an example implementation of a programmable agent and a proxy for the programmable agent in accordance with teachings of this disclosure.

FIG. 2-5 are block diagrams of other example implementations of the programmable agent and the proxy for the programmable agent of FIG. 1 in accordance with teachings of this disclosure.

FIG. 6 is a flowchart of an example method for creating a programmable agent and a proxy for the programmable agent in accordance with teachings of this disclosure.

FIG. 7 is a flowchart representative of example machine-readable instructions and/or example operations that may be executed, instantiated, and/or performed by example programmable circuitry to implement the programmable agent of FIGS. 1, 2, 3, 4, and/or 5.

FIG. 8 is a block diagram of an example processing platform including programmable circuitry structured to execute, instantiate, and/or perform the example machine-readable instructions and/or perform the example operations of FIG. 7.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine-readable instructions of FIGS. 6 and/or 7) to client devices.

In general, the same reference numbers will be used throughout the drawing(s) and accompanying written description to refer to the same or like parts. The figures are not necessarily to scale.

### DETAILED DESCRIPTION

A programmable agent is an autonomous entity (e.g., a software entity) that can monitor and manage processes in a process control system, perform tasks, or otherwise interact with the system. For example, a programmable agent can execute algorithms, decision-making logic, and/or machine learning to interact with the process control system, perform tasks, and dynamically respond to changing conditions in the process control system.

A distributed process control system, such as those used in chemical, pharmaceutical, and/or other processes or process plant(s), typically includes one or more process controllers communicatively coupled to one or more field devices. In such systems, the field devices including, for example, valves, valve positioners, switches and/or sensors (e.g., temperature, pressure, level and flow rate sensors), are located within the process environment and perform process control, alarm and/or management functions such as opening or closing valves, measuring process parameters, etc.

As an example, the DeltaV™ control system sold by Fisher-Rosemount Systems, Inc., an Emerson Automation Solutions company, supports multiple applications stored within and/or executed by different devices located at potentially diverse locations within a process plant. A configuration application, which can be executed by one or more operator workstations, enables users to create and/or change process control applications in the distributed process control system via a communication network. In some examples, a user may create and/or change process control application(s) via function block(s) that define a control strategy or routine for the process control system. For example, a function block can be programmed to perform a control function (e.g., a function such as Proportional-Integral-Derivative (PID)) based on an input and generate an output that can be used to control field device(s) in the process control system (e.g., open a valve). A graphical user interface can be provided to the user at the workstation that enables the user to create or modify function block(s) for the process control system.

Disclosed herein are example systems, apparatus, and methods to enable management (e.g., modifying, debugging, training, tuning) of a programmable agent in a distributed process control system. In examples disclosed herein, a function block serves as a proxy or shadow block in a control platform (e.g., DeltaV™) for the programmable agent, which is located (e.g., stored) elsewhere in the distributed process control system. For example, the programmable agent can be implemented by a container or other compute environment (e.g., a Docker container, a Kubernetes compute environment, an Akka framework) that operates locally or remotely (e.g., in a compute node in an edge environment). A user can manage code (e.g., modify, create, debug) to be executed by the programmable agent at the proxy function block representing the programmable agent using a programmable language (e.g., Python). For example, a user can create or change logic, rules, or algorithms to be executed by the programmable agent using a programmable language at the function block. The code as defined by the programmable language is then deployed (e.g., downloaded, distributed) to the programmable agent, which executes the code. For example, a user can train or tune an artificial intelligence (AI) or machine learning (ML) algorithm executed by the programmable agent via the proxy function block using a programmable language that can generate, for example, large language models or a deep learning model. Thus, examples disclosed herein facilitate efficient integration and management of programmable agents into a process control system via an architecture based on function blocks.

In examples disclosed herein, because the programmable agent is separate (e.g., remote) relative to the control platform that includes the proxy function block, control tasks performed by the control platform can be isolated or substantially isolated from user changes to the programmable agent that may negatively affect the process control routine(s). For example, function blocks that are not associated with the proxy block for the programmable agent can continue to execute control functions or tasks if a user-initiated change to the programmable agent introduces error(s) or otherwise adversely impacts a portion of the control process associated with the code executed by the programmable agent. Thus, in examples disclosed herein, the distributed nature of the process control system can be used to provide for efficient management of programmable agents via user inputs while protecting the process control system.

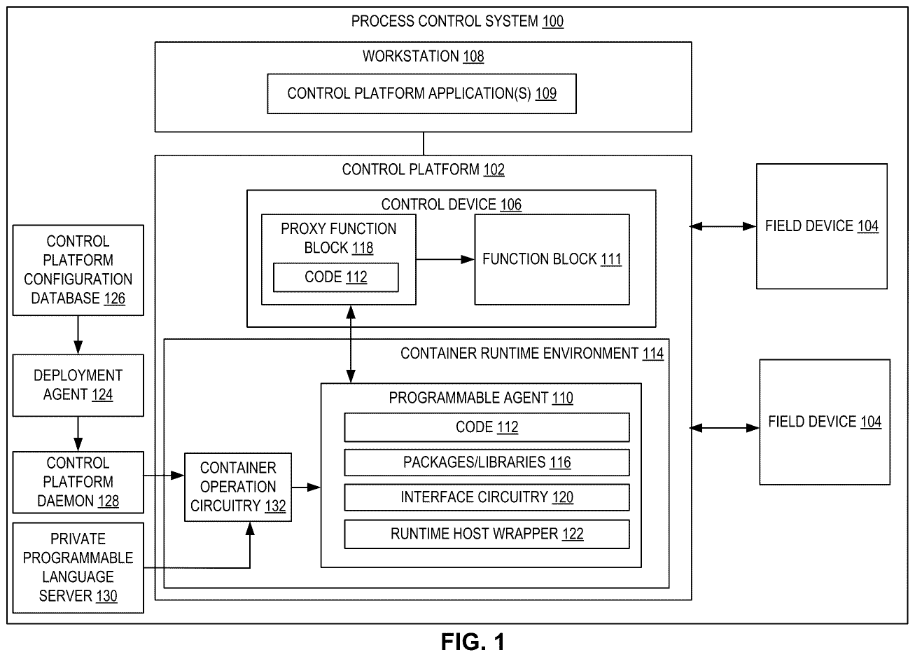

FIG. 1 illustrates an example process control system 100 including a control platform 102 (e.g., DeltaV™) communicatively coupled to one or more field devices 104 (e.g., valves, actuators, sensors). The example control platform 102 includes a control device 106 (e.g., one or more programmable circuits, processor circuitry) to execute algorithms to implement control strategies, processes, and/or routines via the field device(s) 104. In the example of FIG. 1, a workstation 108 is in communication with the control platform 102. The workstation 108 includes one or more application(s) 109 installed thereon to enable user(s) to interact with the control platform 102 (e.g., via graphical user interface(s)). The example process control system 100 of FIG. 1 can include additional control platforms and/or workstations. Also, the control platform 102 can include control devices in addition to the control device 106 shown in FIG. 1.

In the example of FIG. 1, the control device 106 executes algorithms defined by function blocks. The function blocks cause functions within the control scheme to be performed (e.g., process control and/or alarm generation) based on received input(s) and/or cause output(s) to be provided to other blocks within the process control system 100. For example, FIG. 1 illustrates an example function block 111, which can correspond to a PID (Proportional-Integral-Derivative) function block.

The example process control system 100 of FIG. 1 includes a programmable agent 110 (also referred to herein as a host) to execute code 112 to generate an output (e.g., a single value, an array of values, or a set of values). Based on the code 112, the programmable agent 110 operates independently to, for example, monitor processes in the process control system 100, make decisions and/or take corrective actions based on rules and/or training and in response to the monitoring, and/or, more generally, execute algorithms in connection with the process control system 100. For example, the programmable agent 110 can execute machine learning algorithms defined by the code 112. The code 112 of the programmable agent 110 can be customized (e.g., programmed) for the system or industry with which the process control system 100 is associated. The process control system 100 of FIG. 1 can include additional programmable agents.

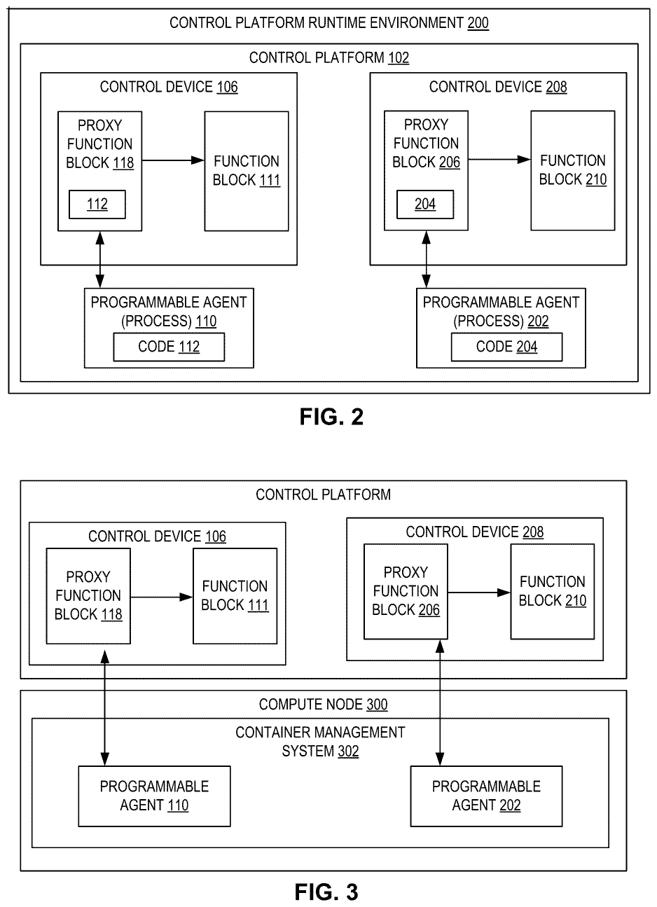

In the example of FIG. 1, the programmable agent or host 110 is implemented by a runtime environment 114 of a container (e.g., a Docker container). The container for the programmable agent 110 is communicatively coupled to the control platform 102 via a network. The container can be located locally (e.g., in a compute environment that also hosts the control platform 102) or remotely (e.g., in a cloud). In some examples, the container can use specialized hardware to run the programmable agent 110, such as graphics processing units (GPUs), Application-Specific Integrated Circuits (ASICs), Field Programmable Gate Array (FPGAs), or central processing units (CPUs). As disclosed herein (FIG. 2-5), the programmable agent or host 110 can be implemented by different compute environments than shown in FIG. 1.

In the example of FIG. 1, the programmable agent 110 includes packages and/or libraries 116 that support execution of the programmable agent 110 in the container runtime environment 114. The packages and/or libraries 116 can be based on the language used to program the programmable agent (e.g., a Python Standard Library) and/or based on the control platform (e.g., a library that allows the programmable language to interact with the control platform runtime data).

In some examples, a user may wish to manage (e.g., modify, create, debug, train, tune) the code 112 executed at the programmable agent 110. For example, the user may wish to parameterize the code 112, debug a portion of the code 112, adjust or tune algorithm(s) defined by the code 112, add new code to the existing code 112 or, more generally, modify the code 112 to affect one or more control strategies in the process control system 100. In the example of FIG. 1, the control device 106 (e.g., one or more programmable circuits) includes a proxy 118 to enable the user to manage the code 112 of the programmable agent 110 via, for example, graphical user interface(s) of the control platform application(s) 109 at the workstation 108. In the example of FIG. 1, the proxy 118 is a function block. The programmable agent 110 includes interface circuitry 120 to communicate with the proxy function block 118 to receive (e.g., download) the code 112 generated at the proxy function block 118 to enable the programmable agent 110 to execute the code 112.

In the example of FIG. 1, the proxy 118 is a shadow function block that includes a copy of the code 112 to be executed by the programmable agent 110 (e.g., a most recent version of the code 112). Put another way, to the user, the code 112 appears to be stored and executed locally via the proxy function block 118. However, the code 112 created via user input(s) at the proxy function block 118 is deployed (e.g., downloaded, distributed) to the programmable agent 110 via the interface circuitry 120. The programmable agent 110 executes the code 112 (e.g., via the container runtime environment 114). Thus, the proxy function block 118 stores an editable copy of the code 112 that is executed at the programmable agent 110. In some examples, prior to downloading the code 112 from the proxy 118, the interface circuitry 120 verifies that the code 112 stored at the proxy function block 118 does not exceed a load threshold in view of resource constraints at, for example, the container runtime environment 114.

The user can access the code 112 stored at the proxy function block 118 via a graphical user interface of the control platform application(s) 109 of the workstation 108 and manage (e.g., modify) the code 112 using a programmable language (e.g., Python, Lang). The (modified) code 112 is stored at the proxy function block 118 and provided to the programmable agent 110 via the interface circuitry 120 (e.g., downloaded as a software package such as a Docker container image). In some examples, the proxy function block 118 replaces a previously saved version of the code 112 with an updated version of the code 112 after modification by the user input(s). Similarly, upon receiving the updated code 112, the programmable agent 110 can replace previous code with the updated code 112 so that the programmable agent 110 executes the most recent version of the code 112. The code 112 can be provided to the programmable agent 110 in response to detection of a change of the code 112 at the proxy function block 118.

In the example of FIG. 1, the separate locations of the proxy function block 118, which stores an editable version of the code 112, and the programmable agent 110, which executes the code 112, provides for safeguarding of the integrity of the process control system 100. For example, if a user-initiated change to the code 112 introduces an error, the effect of the error is limited by the distributed location of the programmable agent 110 relative to the control platform 102.

In some examples, the programmable agent 110 can communicate with runtime environments associated with other programmable languages via a runtime host wrapper 122. For example, a user can edit the code 112 at the proxy function block 118 using Python programming language. The runtime host wrapper 122 of the programmable agent 110 can cause the code 112 (i.e., the modified code 112) received at the programmable agent 110 to be executed in a runtime environment associated with another programmable language by interfacing with interpreters, compilers, libraries, servers, etc. associated with one or more other programmable languages. The other programmable languages can include, for example, variations of the programming language used to manage (e.g., modify) the code 112 at the proxy function block 118 (e.g., variations of Python such as PyPy and Cpython) or different programming language platforms (e.g., Mojo). In some examples, the runtime host wrapper 122 can facilitate switching between different programming language runtime environments based on, for example, a portion of the code 112 being executed.

The example process control system 100 of FIG. 1 can include other components to support the proxy 118 at the control platform 102 and the separately located programmable agent or host 110. For example, a deployment agent 124 can act as a bridge between a configuration database 126 for the control platform 102 and a control platform daemon 128. In some examples, the deployment agent 124 can generate container image(s) that include the code 112 as modified at the proxy 118 and supporting package(s) by communicating with a private programmable language server 130. The private programmable language server 130 can define packages for the programmable language used for the code 112 that are authorized to be used in connection with the process control system 100. The container image(s) can be provided to the container runtime environment 114 for execution of the code at the programmable agent 110.

The control platform daemon 128 can emulate the download and diagnostics features of the runtime environment of the control platform 102 in a non-control platform environment, such as the container runtime environment 114. The control platform daemon 128 can translate requests from the deployment agent 124 into operations to satisfy requests at the container runtime environment 114. The control platform daemon 128 can also interact with container operation circuitry 132 to coordinate and monitor the deployment and execution of the programmable agent 110 at the container runtime environment 114. The container operation circuitry 132 can verify that container(s) are running and monitors container performance. The control platform configuration database 126, the deployment agent 124, the control platform daemon 128, and the private programmable language server 130 can be implemented by one or more control devices, applications, servers, machines, etc., in the example process control system 100.

In the example of FIG. 1, the programmable agent 110 is implemented in the runtime environment 114 of a container. However, the programmable agent 110 can be implemented in other compute environments, as disclosed in connection with FIGS. 2-5.

FIG. 2 is a block diagram of an example implementation of the programmable agent 110 by a runtime environment 200 that implements the control platform 102. In this example, in the example of FIG. 2, the programmable agent or host 110 is a process executed by the runtime environment 200 that implements the control platform 102. Put another way, the programmable agent or host 110 is implemented in an embedded environment with the control platform 102. In the example of FIG. 2, the programmable agent 110 (i.e., process) includes a directory structure to execute the code 112 received from the proxy function block 118. The programmable agent 110 (i.e., process) of FIG. 2 includes packages and libraries associated with the programmable language (e.g., Python). As shown in FIG. 2, the programmable agent 110 is external to the control device 106 that includes the proxy function block 118 in the runtime environment 200.

As also shown in FIG. 2, a second programmable agent 202 can be implemented by the runtime environment 200. Code 204 executed by the second programmable agent 202 can be managed (e.g., modified) by a user via a second proxy function block 206, as disclosed in connection with the first proxy function block 118 of the first programmable agent 110. The second proxy function block 206 can be implemented by a second control device 208 (e.g., one or more programmable circuits) that also implements other function block(s) 210. In some examples, the second proxy function block 206 can be implemented by the first control device 106. In some examples, the first and second programmable agents 110, 202 can share libraries associated with common programmable languages. The example of FIG. 2 can include fewer or additional programmable agents.

In the example of FIG. 2, the deployment agent 124 (FIG. 1) is responsible for packaging the programmable code 112, 204 and any code dependencies into a compressed and digitally signed archive before the code 112, 204 is distributed to the respective programmable agent 110, 202 via the corresponding proxy function block 118, 206. In response, the control platform runtime environment 200 verifies the digital signature before unpacking the archive including the code 112, 204 into a directory structure that is used by the programmable agent 110, 202.

FIG. 3 is a block diagram of an example implementation of the programmable agent(s) 110, 202 by a compute node 300. In the example of FIG. 3, a container management system 302 (e.g., a Kubernetes cluster) is installed on the compute node 300. The container management system 302 runs the programmable agent(s) 110, 202 via container(s) of the container management system 302. The compute node 300 can be a virtual machine or a bare-metal machine that is hosted on-premises (e.g., in the process plant) or in the cloud. The compute node 300 of FIG. 3 can include hardware (e.g., CPUs, GPUs, memory, a network fabric, etc.) that facilitates execution of the code 112, 204 by the programmable agent(s) 110, 202. For example, the compute node 300 can include hardware (e.g., GPU(s)) that supports efficient execution of machine learning and/or AI algorithm(s) defined by the code 112, 204. The example of FIG. 3 can include additional compute nodes and/or programmable agents.

The compute node 300 of FIG. 3 can interact with the control platform 102 (e.g., via software executed at the compute node 300 and/or the control platform 102). For example, the control platform 102 can generate and output instructions to commission or decommission (e.g., active or deactivate) the compute node 300, assign container(s) to run in the compute node 300, cause a container image to be deployed (e.g., downloaded) at the compute node 300, monitor the status of the compute node 300, etc.

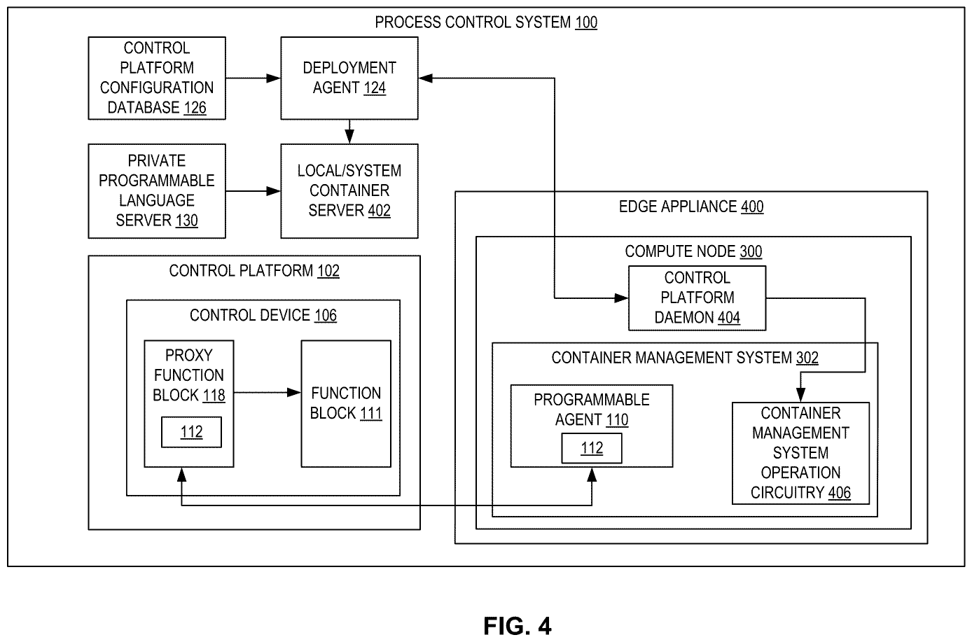

FIG. 4 illustrates an example in which the compute node 300 of FIG. 3 including the programmable agent 110 is located in an edge appliance 400 of the process control system 100 of FIG. 1. In this example, the compute node 300 is a virtual machine that includes containers managed by the container management system 302 (e.g., a Kubernetes cluster), where the containers can access data stored in a cloud as part of an edge environment. The proxy 118 communicates with the programmable agent 110 via the containers running within the virtual machine or compute node 300 to transfer code 112 modified at the proxy function block 118 to the programmable agent 110. For illustrative purposes, one programmable agent 110 is shown in FIG. 4; however, the virtual machine or compute node 300 of could implement additional programmable agents.

In the example of FIG. 4, one or more components support communication between the proxy 118 at the control platform 102 and the programmable agent 110 in the edge environment. For example, the deployment agent 124 acts as a bridge between the control platform configuration database 126 and a control platform daemon 404 on the compute node 300. The deployment agent 124 can also generate container image(s) using a local container server 402 of the process control system 100 and the private programmable language server 130.

The control platform daemon 404 of the compute node 300 of FIG. 4 translates control platform operations into Application Programming Interface (API) calls or requests for the container management system 302 (e.g., Kubernetes API calls). The control platform daemon 404 also monitors the container management system 302 (e.g., Kubernetes cluster) on behalf of the control platform 102. The control platform daemon 404 is in communication with container management system operation circuitry 406. The container management system operation circuitry 406 coordinates and monitors deployment and execution of custom resource definitions (CRDs) specific to the control platform 102 that integrate control platform security with the container management system 302 and pod(s) (e.g., Kubernetes pod(s)) that run the programmable agent 110.

During a distribution or deployment (e.g., download) operation to transfer the code 112 from the proxy function block 118 to the programmable agent 110, the deployment agent 124 builds a container image based on the programmable code 112 of the proxy function block 118 and package dependencies for the programmable language using the private programmable language server 130. The container image is stored in a container registry on the local/system container server 402. The deployment agent 124 instructs the control platform daemon 404 to deploy the generated container image. In response, the control platform daemon 404 in the compute node 300 interacts with the container management system 302 (e.g., the Kubernetes cluster) to perform the distribution (e.g., download) operation using the container registry of the local/system container server 402. Also, the container management system 302 interacts with the container management system operation circuitry 406 while deploying containerized workloads. In the example of FIG. 4, the control platform configuration database 126, the deployment agent 124, the local/system container server 402, and the private programmable language server 130 can be implemented by one or more control devices, applications, servers, machines, etc., in the example process control system 100.

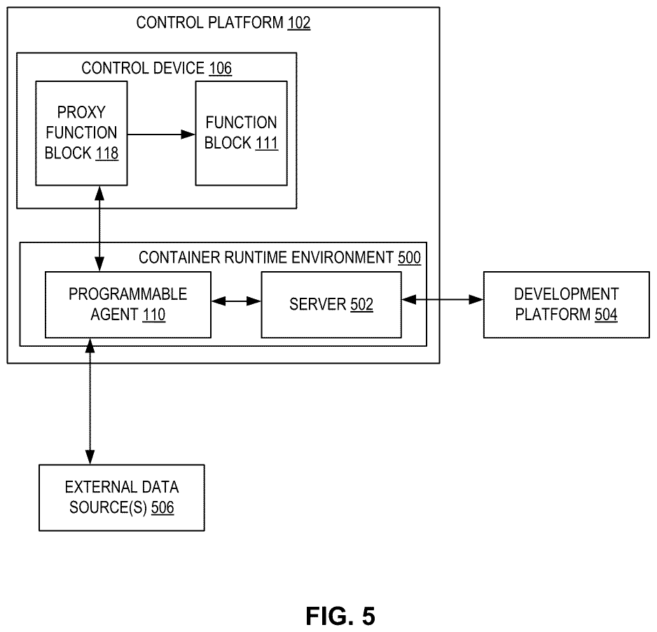

FIG. 5 is a block diagram of an example implementation of the programmable agent 110 by a runtime environment that is associated with a development setting (e.g., open-source software). The example of FIG. 5 can be used for, for example, debugging code. In the example of FIG. 5, the programmable agent 110 is implemented by a container runtime environment 500 similar to the example of FIG. 1. In FIG. 5, the container runtime environment 500 includes a server 502 that enables users to interact with the runtime environment 500 via an external development platform 504 (e.g., a web-based development platform such as a Jupyter notebook).

In the example of FIG. 5, the programmable agent 110 is in communication with one or more data sources 506 that are external to the control platform 102. The external data source(s) 506 can include, for example, an external web service. In some examples, the deployment location of the programmable agent 110 (and, thus, the code 112) can define whether the programmable agent 110 is able to interact with external data source(s) in view of, for example, cybersecurity protocols, reliability, network latencies, etc. For example, while the programmable agent 110 may be permitted to interact with the external data source(s) 506 when implemented in the development environment of FIG. 5 and/or the edge environment of FIG. 4, the programmable agent 110 may not be permitted to interact with the external data source(s) 506 when deployed in the embedded environment of FIG. 2 because of security concerns.

FIG. 1-5 are block diagrams of example implementations of the control device 106, 208; the programmable agent 110, 202; the deployment agent 124; the control platform daemon 128, 404; the private programmable language server 130; the container operation circuitry 132; the local/system container server 402; and the container management system operation circuitry 406. The control device 106, 208; the programmable agent 110, 202; the deployment agent 124; the control platform daemon 128, 404; the private programmable language server 130; the container operation circuitry 132; the local/system container server 402; and/or the container management system operation circuitry 406 of FIG. 1-5 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the control device 106, 208; the programmable agent 110, 202; the deployment agent 124; the control platform daemon 128, 404; the private programmable language server 130; the container operation circuitry 132; the local/system container server 402; and/or the container management system operation circuitry 406 of FIG. 1-5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 1-5 may, thus, be instantiated at the same or different times. Some or all of the circuitry of FIG. 1-5 may be instantiated, for example, in one or more threads executing concurrently on hardware and/or in series on hardware. Moreover, in some examples, some or all of the circuitry of FIGS. 1-5 may be implemented by microprocessor circuitry executing instructions and/or FPGA circuitry performing operations to implement one or more virtual machines and/or containers.

While an example manner of implementing the control device 106, 208; the programmable agent 110, 202; the deployment agent 124; the control platform daemon 128, 402; the private programmable language server 130; the container operation circuitry 132; the local/system container server 402; and the container management system operation circuitry 406 are illustrated in FIG. 1-5, one or more of the elements, processes, and/or devices illustrated in FIG. 1-5 may be combined, divided, re-arranged, omitted, eliminated, and/or implemented in any other way. Further, the example control device 106, 208; the example programmable agent 110, 202; the example deployment agent 124; the example control platform daemon 128, 404; the example private programmable language server 130; the example container operation circuitry 132; the example local/system container server 402; and the example container management system operation circuitry 406 of FIG. 1-5 may be implemented by hardware alone or by hardware in combination with software and/or firmware. Thus, for example, the example control device 106, 208; the example programmable agent 110, 202; the example deployment agent 124; the example control platform daemon 128, 404; the example private programmable language server 130; the example container operation circuitry 132; the example local/system container server 402; and the example container management system operation circuitry 406 of FIG. 1-5 could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example control device 106, 208; the example programmable agent 110, 202; the example deployment agent 124; the example control platform daemon 128, 404; the example private programmable language server 130; the example container operation circuitry 132; the example local/system container server 402; and the example container management system operation circuitry 406 of FIG. 1-5 may include one or more elements, processes, and/or devices in addition to, or instead of, those illustrated in FIG. 1-5, and/or may include more than one of any or all of the illustrated elements, processes and devices.

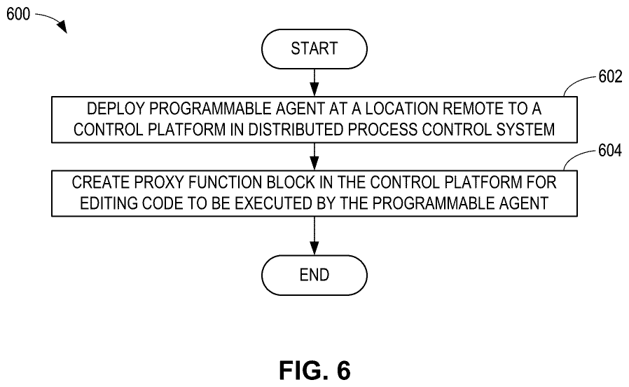

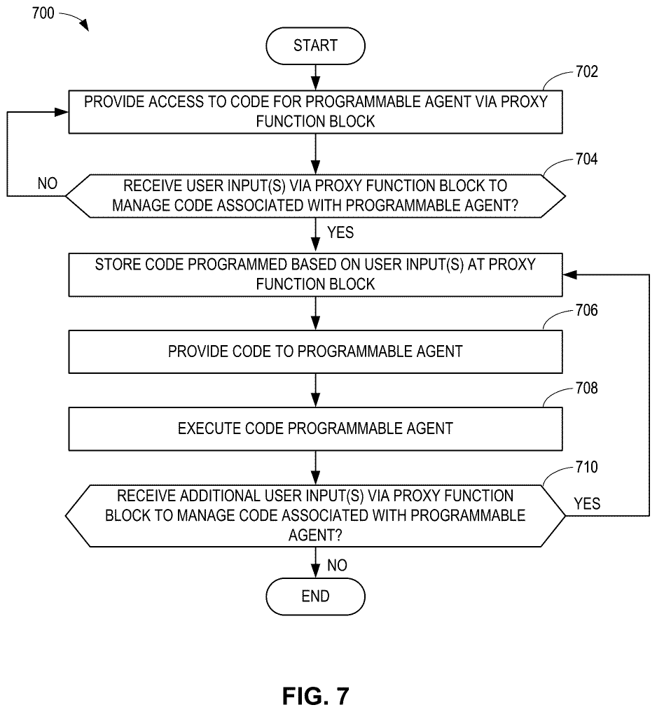

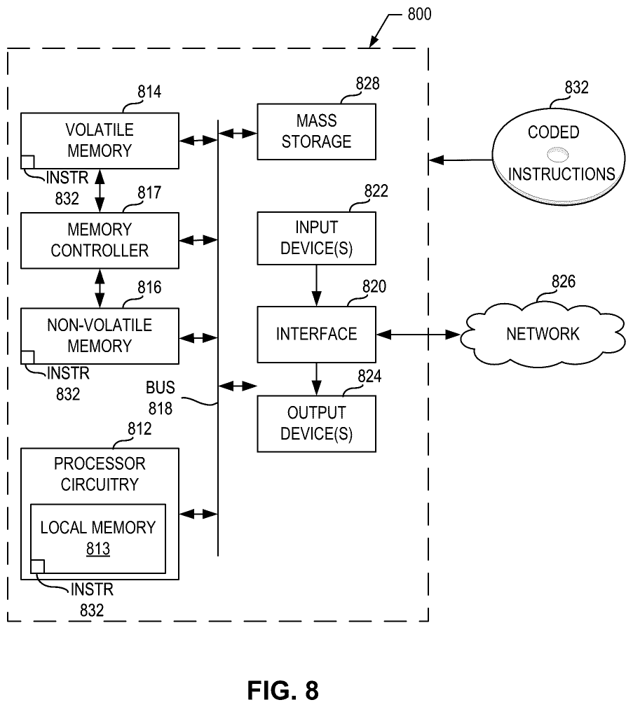

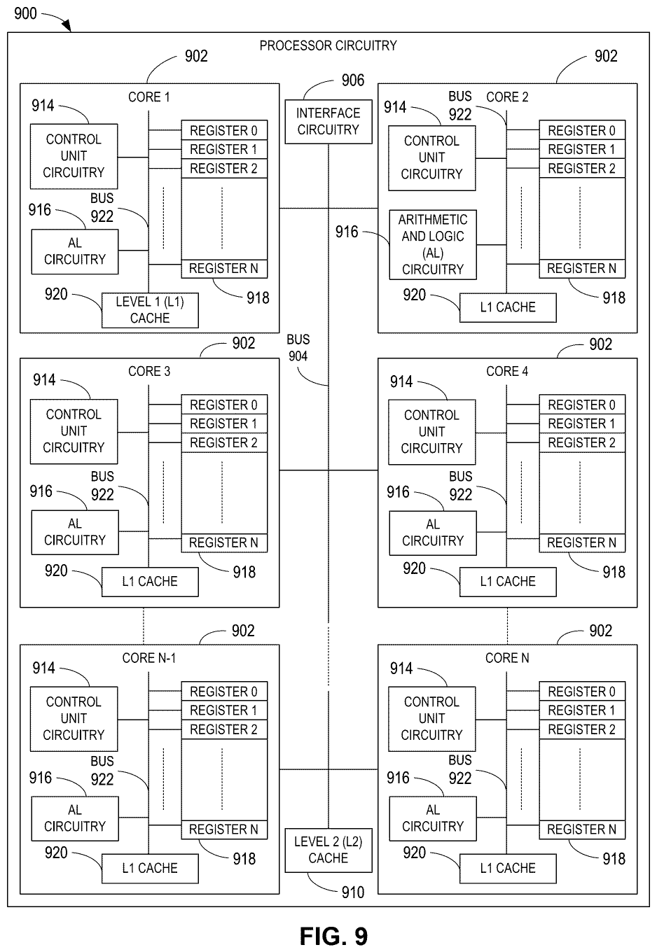

Flowchart(s) representative of example machine-readable instructions, which may be executed by programmable circuitry to implement and/or instantiate the example control device 106, 208; the example programmable agent 110, 202; the example deployment agent 124; the example control platform daemon 128, 404; the example private programmable language server 130; the example container operation circuitry 132; the example local/system container server 402; and the example container management system operation circuitry 406 of FIG. 1-5 and/or representative of example operations which may be performed by programmable circuitry to implement and/or instantiate the example control device 106, 208; the example programmable agent 110, 202; the example deployment agent 124; the example control platform daemon 128, 404; the example private programmable language server 130; the example container operation circuitry 132; the example local/system container server 402; and the example container management system operation circuitry 406 of FIGS. 1-5 , are shown in FIGS. 6 and 7. The machine-readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 6 and 7, many other methods of implementing the example control device 106, 208; the example programmable agent 110, 202; the example deployment agent 124; the example control platform daemon 128, 404; the example private programmable language server 130; the example container operation circuitry 132; the example local/system container server 402; and the example container management system operation circuitry 406 of FIG. 1-5 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks, and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 6 and 7 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic, and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 6 is a flowchart representative of example machine-readable instructions and/or example operations 600 that may be executed, instantiated, and/or performed by programmable circuitry to implement the programmable agent 110, 202 including code 112, 204 that can be managed (e.g., modified, trained, debugged) via the proxy function block 118, 206 associated with the process control system 100 of FIG. 1-5. At block 602, the programmable agent 110, 202 is deployed at a location remote to the control platform 102 of the process control system 100, such as in the container runtime environment 114, 500 (FIGS. 1, 5), as a process in the runtime environment 200 of the control platform 102 (FIG. 2), or in a container management system 302 (FIG. 3) of a compute node 300, which can be further implemented by an edge appliance 400 (FIG. 4).

At block 604, the example operations 600 includes creating the proxy function block 118, 206 in the control platform 102 (e.g., at a control device 106, 208) to enable the code 112, 204 that is to be executed by the programmable agent 110, 202 to be managed (e.g., modified, debugged, edited) at the proxy function block 118, 206.

FIG. 7 is a flowchart representative of example machine-readable instructions and/or example operations 700 that may be executed, instantiated, and/or performed by programmable circuitry to enable a user to manage code 112, 204 to be executed by the programmable agent 110, 202 via the proxy 118, 206 (e.g., a function block) of FIG. 1-5. At block 702, access to the code 112, 204 for the programmable agent 110, 202 is provided via the proxy function block 118, 206 in the control platform 102 (e.g., via a graphical user interface of the control platform application 109 at the workstation 108). If, at block 704, a user input(s) are received via the proxy function block 118, 206 to manage (e.g., modify, debug, train, tune) the code 112, 204, the example operations of FIG. 7 proceed to store the (e.g., updated) code 112, 204 at the proxy function block 118, 206. Also, at block 706, the (e.g., updated) code 112, 204 is provided to the programmable agent 110, 202 via, for example, download operation(s) managed by, for example, the deployment agent 124; the control platform daemon 128, 404; and the operation circuitry 132, 406 for the runtime environment that implements the programmable agent 110, 202.

At block 708, the programmable agent 110, 202 executes the code 112, 204 (i.e., the version of the code 112, 204 received from the proxy function block 118, 206). The example operations 700 of FIG. 7 end when no further user inputs are received in connection with the code 112, 204 via the proxy function block 118, 206 (block 710).

FIG. 8 is a block diagram of an example programmable circuitry platform 800 structured to execute and/or instantiate the example machine-readable instructions and/or the example operations of FIGS. 6 and/or 7 to implement the control device 106, 208, the programmable agent 110, 202, the deployment agent 124, the control platform daemon 128, the control platform daemon 404, the private programmable language server 130, the container operation circuitry 132, the local/system container server 402, and/or the container management system operation circuitry 406 of FIGS. 1-5. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, VPUs, DSPs, and/or microcontrollers from any desired family or manufacturer. The programmable circuitry 812 may be implemented by one or more semiconductor based (e.g., silicon based) devices.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 832, which may be implemented by the machine-readable instructions of FIGS. 6 and 7, may be stored in the mass storage device 828, in the volatile memory 814, in the non-volatile memory 816, and/or on at least one non-transitory computer-readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 6 and/or 7 to effectively instantiate the circuitry of FIG. 1-5 as logic circuits to perform operations corresponding to those machine-readable instructions. In some such examples, the control device 106, 208, the programmable agent 110, 202, the deployment agent 124, the control platform daemon 128, the control platform daemon 404, the private programmable language server 130, the container operation circuitry 132, the local/system container server 402, and/or the container management system operation circuitry 406 of FIGS. 1-5 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine-readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine-readable instructions and/or operations represented by the flowcharts of FIGS. 6 and 7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

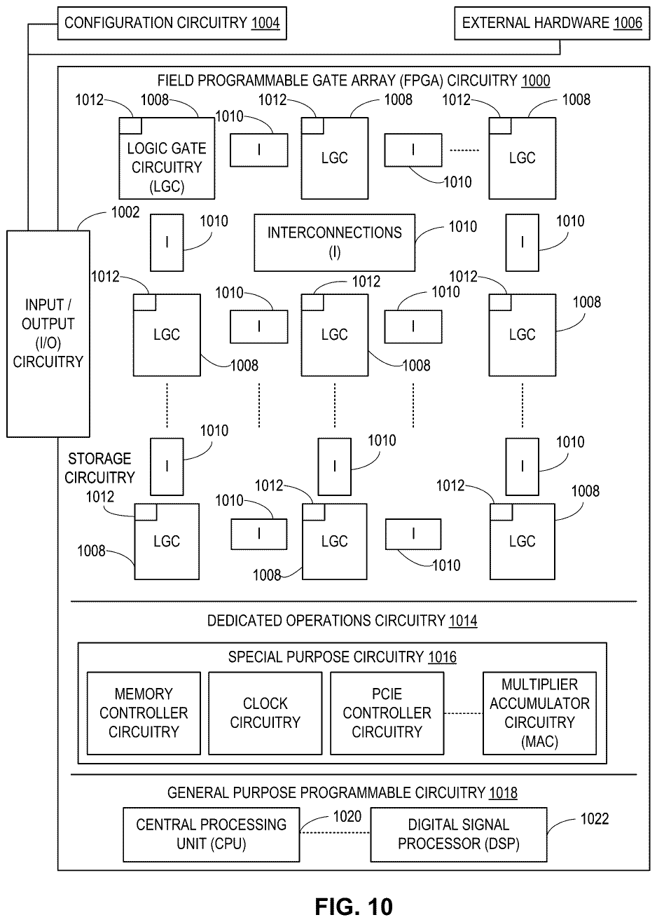

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine-readable instructions. However, once configured, the FPGA circuitry 1000 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine-readable instructions represented by the flowchart(s) of FIGS. 6 and/or 7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 6 and/or 7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6 and/or 7. As such, the FPGA circuitry 1000 may be configured and/or structured to effectively instantiate some or all of the operations/functions corresponding to the machine-readable instructions of the flowchart(s) of FIGS. 6 and/or 7 as dedicated logic circuits to perform the operations/functions corresponding to those software instructions in a dedicated manner analogous to an ASIC. Therefore, the FPGA circuitry 1000 may perform the operations/functions corresponding to the some or all of the machine-readable instructions of FIGS. 6 and/or 7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine-readable instructions of FIGS. 6 and/or 7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine-readable instructions represented by the flowchart(s) of FIGS. 6 and/or 7 to perform first operation(s)/function(s), the FPGA circuitry 1000 of FIG. 10 may be configured and/or structured to perform second operation(s)/function(s) corresponding to a second portion of the machine-readable instructions represented by the flowcharts of FIGS. 6 and/or 7, and/or an ASIC may be configured and/or structured to perform third operation(s)/function(s) corresponding to a third portion of the machine-readable instructions represented by the flowcharts of FIGS. 6 and/or 7.

It should be understood that some or all of the circuitry of FIG. 1-5 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIGS. 1-5 may be instantiated, for example, in one or more threads executing concurrently and/or in series. For example, the microprocessor 900 of FIG. 9 may execute machine-readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 1-5 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

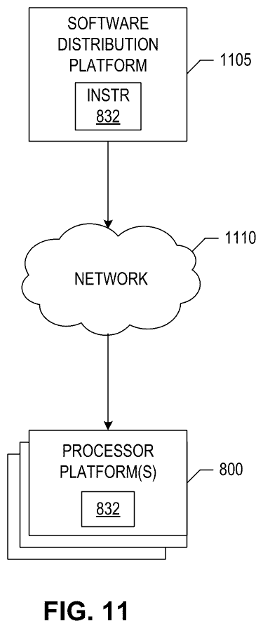

A block diagram illustrating an example software distribution platform 1105 to distribute software such as the example machine-readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine-readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine-readable instructions 832, which may correspond to the example machine-readable instructions of FIGS. 6 and/or 7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 832 from the software distribution platform 1105. For example, the software, which may correspond to the example machine-readable instructions of FIGS. 6 and 7, may be downloaded to the example programmable circuitry platform 800, which is to execute the machine-readable instructions 832 to implement the control device 106, 208, the programmable agent 110, 202, the deployment agent 124, the control platform daemon 128, the control platform daemon 404, the private programmable language server 130, the container operation circuitry 132, the local/system container server 402, and/or the container management system operation circuitry 406. In some examples, one or more servers of the software distribution platform 1105 periodically offer, transmit, and/or force updates to the software (e.g., the example machine-readable instructions 832 of FIG. 8) to ensure improvements, patches, updates, etc., are distributed and applied to the software at the end user devices. Although referred to as software above, the distributed “software” could alternatively be firmware. “Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that provide for management of programmable agents (e.g., code executed by the programmable agents) via a proxy in a control system platform. Examples disclosed herein enable a user to modify, debug, train, tune, etc. algorithms defined by the code using a function block, which serves as a proxy for the programmable agent. The code, as programmed at the function block, is provided to the programmable agent (e.g., via download operation(s)) for execution. In examples disclosed herein, the programmable agent is distributed in the process control system such that the programmable agent is separate from the control platform. Thus, examples disclosed herein enable a user to efficiently modify the code using programmable languages while protecting the integrity of the process control system.

Example systems, apparatus, and methods for managing programmable agents are disclosed. Further examples and combinations thereof include the following:

Example 1 includes a process control system including a programmable agent; a control device to store, at a function block, a modification to code associated with the programmable agent, the modification received via the function block, the programmable agent separate from the function block in the process control system; and interface circuitry to cause the code including the modification to be provided to the programmable agent, the programmable agent to execute the code including the modification to generate an output for the process control system.

Example 2 includes any preceding clause(s) of Example 1, wherein the programmable agent is implemented by a container.

Example 3 includes any preceding clause(s) of any one or more of Examples 1 or 2, wherein the programmable agent is implemented by a compute node of an edge appliance.

Example 4 includes any preceding clause(s) of any one or more of Examples 1-3, wherein the programmable agent is a process executed by a runtime environment.

Example 5 includes any preceding clause(s) of any one or more of Examples 1-4, wherein the function block is accessible via a graphical user interface.

Example 6 includes any preceding clause(s) of any one or more of Examples 1-5, wherein the interface circuitry is to cause the code including the modification to be provided to the programmable agent via a download operation.

Example 7 includes any preceding clause(s) of any one or more of Examples 1-6, wherein the programmable agent is in communication with a data source external to the process control system.

Example 8 includes any preceding clause(s) of any one or more of Examples 1-7, wherein the programmable agent includes a library associated with a programming language corresponding to the code.

Example 9 includes a non-transitory machine-readable storage medium comprising machine-readable instructions to cause at least one programmable circuit to at least responsive to a user input, store code at a function block, the code defined by a programmable language corresponding to the user input; output the code for execution via a host, the host different than the function block; and execute the code via the host.

Example 10 includes any preceding clause(s) of Example 9, wherein the machine-readable instructions are to cause one or more of the at least one programmable circuit to generate a container image including the code and cause the container image to be output to the host.

Example 11 includes any preceding clause(s) of any one or more of Examples 9 or 10, wherein the machine-readable instructions are to cause one or more of the at least one programmable circuit to generate the container image based on a package for the programmable language defining the code.

Example 12 incudes any preceding clause(s) of any one or more of Examples 9-11, wherein the code is defined by a first programming language, the host is to execute the code via a first runtime environment, and the machine-readable instructions are to cause one or more of the at least one programmable circuit to communicate with a second runtime environment associated with a second programming language.

Example 13 includes any preceding clause(s) of any one or more of Examples 9-12, wherein the machine-readable instructions are to cause one or more of the at least one programmable circuit to verify a digital signature associated with a package including the code prior to execution of the code.

Example 14 includes any preceding clause(s) of any one or more of Examples 9-13, wherein the host is implemented by a compute node and the machine-readable instructions are to cause one or more of the at least one programmable circuit to activate the compute node.

Example 15 includes a system including a programmable agent to execute a code; and a proxy for the programmable agent, the code editable via the proxy to generate a modified code, the programmable agent to access the modified code via the proxy and execute the modified code.

Example 16 includes any preceding clause(s) of Example 15, wherein the proxy is a function block of a process control system.

Example 17 includes any preceding clause(s) of any one or more of Examples 15 or 16, wherein the programmable agent is implemented via a runtime environment of a container.

Example 18 includes any preceding clause(s) of any one or more of Examples 15-17, wherein the programmable agent is a first programmable agent, the proxy is a first proxy, and further including a second programmable agent and a second proxy for the second programmable agent, the second proxy different than the first proxy.

Example 19 includes any preceding clause(s) of any one or more of Examples 15-18, further including a compute node, wherein the programmable agent is implemented at the compute node.

Example 20 includes any preceding clause(s) of any one or more of Examples 15-19, wherein the compute node includes a graphics processing unit to execute one or more algorithms defined by the code.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A process control system comprising:
a programmable agent;
a control device to store, at a function block, a modification to code associated with the programmable agent, the modification received via the function block, the programmable agent separate from the function block in the process control system; and
interface circuitry to cause the code including the modification to be provided to the programmable agent,
the programmable agent to execute the code including the modification to generate an output for the process control system.

2. The process control system of claim 1, wherein the programmable agent is implemented by a container.

3. The process control system of claim 1, wherein the programmable agent is implemented by a compute node of an edge appliance.

4. The process control system of claim 1, wherein the programmable agent is a process executed by a runtime environment.

5. The process control system of claim 1, wherein the function block is accessible via a graphical user interface.

6. The process control system of claim 1, wherein the interface circuitry is to cause the code including the modification to be provided to the programmable agent via a download operation.

7. The process control system of claim 1, wherein the programmable agent is in communication with a data source external to the process control system.

8. The process control system of claim 1, wherein the programmable agent includes a library associated with a programming language corresponding to the code.

9. A non-transitory machine-readable storage medium comprising machine-readable instructions to cause at least one programmable circuit to at least:
responsive to a user input, store code at a function block, the code defined by a programmable language corresponding to the user input;
output the code for execution via a host, the host different than the function block; and
execute the code via the host.

10. The non-transitory machine-readable storage medium of claim 9, wherein the machine-readable instructions are to cause one or more of the at least one programmable circuit to generate a container image including the code and cause the container image to be output to the host.

11. The non-transitory machine-readable storage medium of claim 10, wherein the machine-readable instructions are to cause one or more of the at least one programmable circuit to generate the container image based on a package for the programmable language defining the code.

12. The non-transitory machine-readable storage medium of claim 9, wherein the code is defined by a first programming language, the host is to execute the code via a first runtime environment, and the machine-readable instructions are to cause one or more of the at least one programmable circuit to communicate with a second runtime environment associated with a second programming language.

13. The non-transitory machine-readable storage medium of claim 9, wherein the machine-readable instructions are to cause one or more of the at least one programmable circuit to verify a digital signature associated with a package including the code prior to execution of the code.

14. The non-transitory machine-readable storage medium of claim 9, wherein the host is implemented by a compute node and the machine-readable instructions are to cause one or more of the at least one programmable circuit to activate the compute node.

15. A system comprising:
a programmable agent to execute a code; and
a proxy for the programmable agent, the code editable via the proxy to generate a modified code, the programmable agent to access the modified code via the proxy and execute the modified code.

16. The system of claim 15, wherein the proxy is a function block of a process control system.

17. The system of claim 15, wherein the programmable agent is implemented via a runtime environment of a container.

18. The system of claim 15, wherein the programmable agent is a first programmable agent, the proxy is a first proxy, and further including a second programmable agent and a second proxy for the second programmable agent, the second proxy different than the first proxy.

19. The system of claim 15, further including a compute node, wherein the programmable agent is implemented at the compute node.

20. The system of claim 19, wherein the compute node includes a graphics processing unit to execute one or more algorithms defined by the code.
